(19) United States
(12) Patent Application Publication
(10) Pub. No.: US 2008/0180191 A1
(43) Pub. Date: Jul. 31, 2008

(54) Variable phase shifter

(76) Inventors: Duk-Yong Kim, Yongin-si (KR); Kyoung-Ho Lee, Seoul (KR); In-Young Lee, Hwaseong-si (KR)

Correspondence Address: CHA & REITER, LLC, 210 ROUTE 4 EAST STE 103, PARAMUS, NJ, 07652, US

(21) Appl. No.: 12/006,996

(22) Filed: Jan. 8, 2008

(30) Foreign Application Priority Data
Jul. 19, 2005 (KR) 2005-65314
Nov. 30, 2005 (KR) PCT/KR2005/004069

(51) Int. Cl. H01P 1/18

(52) U.S. Cl. 333/161

(57) ABSTRACT

A variable phase shifter is provided. In the variable phase shifter, a fixed substrate, which is a dielectric substrate, is fixedly mounted in a housing and has at least one arc-shaped microstrip line on one surface thereof. A rotation substrate, which is a dielectric substrate, is rotatably mounted in the housing, in contact with the other surface of the fixed substrate and has a slot line on the contact surface thereof. Microstrip-slot line coupling takes place between the microstrip line and the slot line even during rotation. Both ends of the microstrip line are connected to an output port of the variable phase shifter and the slot line is electrically connected to an input port of the variable phase shifter, for receiving an input signal.

### TECHNICAL FIELD

The present invention relates generally to a phase shifter for use in shifting a phase of an input signal and, more particularly, but not exclusively, to a variable phase shifter capable of adjustable distribution of the input signals and variable control of the phase shifting.

### BACKGROUND ART

It is appreciated in this art of technology that a phase shifter may be most advantageously utilized for various applications such as, for example, an RF (radio frequency) analog signal processing stage for phase modulation, as well as beam control in a phase array antenna in a mobile communication system. One of the operating principles of such a variable phase shifter is that an input signal is forced to delay for a given time duration so as to generate a phase difference between the input signal and an output signal, using various delaying methods such as, for example, simply making a certain change in a physical length of a transmission path or a signal transfer rate in the transmission path. This phase shifter is commonly designed in a scheme of the variable phase shifter capable of shifting a phase of the input signal in a certain range of phases, for instance, by means of making a slight change in a length of the transmission path as desired.

Nowadays, one of common demands in the mobile communication systems is a technique for adaptively varying phases in respective radiating elements of a phase array antenna for adjusting an angle of a vertical beam radiated from the phase array antenna of a certain base station to thereby control coverage of the base station. Thus, it has essentially led to development of various schemes of phase shifters. Such a variable phase shifter may generally have a scheme for making a distribution of an input signal to plural outputs and then adaptively controlling a phase difference in their respective output signals. One example of these variable phase shifters is disclosed in an International Patent Publication No. WO 01/013459A1 (a corresponding Korean Patent Application No. 2002-7001916) entitled “High-frequency phase shifter unit” filed in the name of KATHREIN-WERKE KG and invented by Göttl, Maximilian, et al.

Recently, a rapid progress in the technical field of mobile communication systems has been made so far, which essentially requires higher performance of RF signal processing technique in use. Consequently, a diversity of extensive researches have been carried out by a lot of researchers for better performance and more efficient construction of the variable phase shifters.

### DISCLOSURE OF INVENTION

Therefore, according to one aspect of the present invention, there is provided a variable phase shifter of more improved performance than the state of the art phase shifter.

According to another aspect of the present invention, there is provided a variable phase shifter capable of implementation with smaller size and more stable mechanical structure.

In a preferred embodiment of the present invention to achieve the above aspects of the invention, the variable phase shifter includes a housing and a fixed substrate, made of a dielectric substrate, which is fixedly mounted to the housing and has at least one arc-shaped micro-strip line on one surface thereof. A rotational substrate, made of a dielectric substrate, is rotatably mounted to the housing, in contact with the other surface of the fixed substrate, and has a slot line on the contact surface thereof. Micro-strip-slot line coupling takes place between the micro-strip line and the slot line even during rotation. Both ends of the micro-strip line are connected to an output port of the variable phase shifter and the slot line is electrically connected to an input port of the variable phase shifter, for receiving an input signal.

### BRIEF DESCRIPTION OF THE DRAWING

The foregoing and other features and advantages of the invention will be apparent from the following detailed description of a preferred embodiment as illustrated in the accompanying drawings, wherein:

FIGS. 1a and 1b respectively show a disassembled perspective view of a variable phase shifter according to a preferred embodiment of the present invention;

FIGS. 2a and 2b respectively show a detailed perspective view of a fixed substrate and a rotational substrate of FIGS. 1a and 1b;

FIG. 3 schematically shows a plan view of one exemplary arrangement of the fixed substrate disposed on the rotational substrate of FIG. 1a;

FIG. 4 schematically shows a plan view (a) and a bottom view (b) of the rotational substrate; and

FIG. 5 schematically shows a cross-sectional view, taken along a line A-A′ of FIG. 3, of one exemplary arrangement of the fixed substrate disposed on the rotational substrate of FIG. 1a.

### BEST MODE FOR CARRYING OUT THE INVENTION

Hereinafter, a preferred embodiment of the present invention will be described in more detail with reference to the attached drawings, wherein same reference characters refer to the same parts or components throughout the various views. The drawings are not necessarily to scale, but the emphasis instead is placed upon illustrating the principles of the invention. In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. For the purpose of simplicity and clarity, detailed descriptions of well-known devices and methods are omitted so as not to obscure the description of the present invention with unnecessary detail.

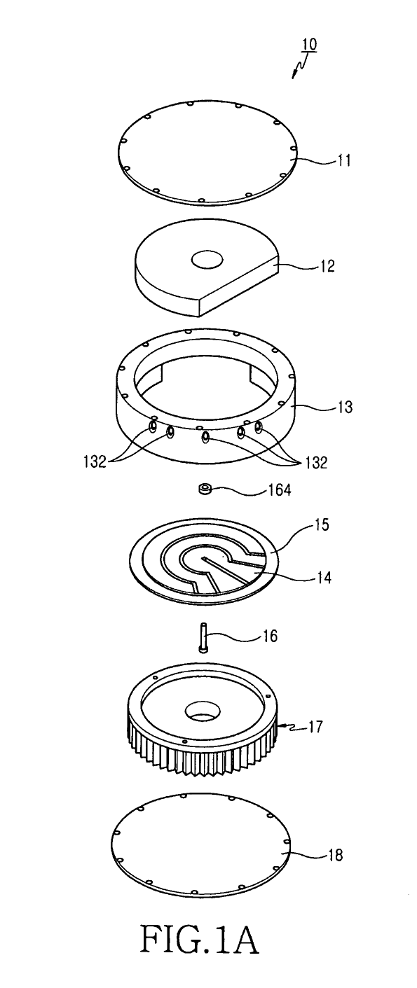

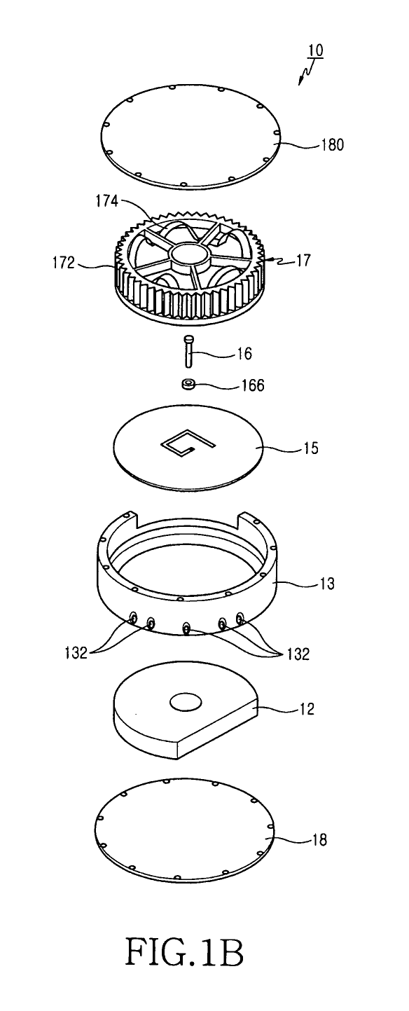

Referring now FIGS. 1a and 1b, description is made to the construction of a variable phase shifter 10 according to a preferred embodiment of the present invention, in which FIG. 1a shows a top perspective view of the variable phase shifter 10 disassembled and FIG. 1b shows a bottom perspective view of the variable phase shifter 10 disassembled. The variable phase shifter 10 has a tubular housing 13 in which is formed a suitable receiving space. Into the receiving space of the housing 10 are inserted a fixed substrate 14 and a rotational substrate 15 arranged to contact each other slidably, in such a manner that a bottom surface of the fixed substrate 14 meets an upper surface of the rotational substrate 15. Here, although the fixed substrate 14 and the rotational substrate 15 are arranged up and down to contact each other, they are not fixedly coupled to each other. Hence, when the rotational substrate 15 is allowed to rotate, a sliding movement is made on an upper surface of the rotational substrate 15 in touch with the fixed substrate 14, as described later in more detail.

A rotation body 17 that rotates through the aid of an external driving motor is installed underneath the rotational substrate 15 inside the housing 13. This rotation body 15 is provided with gears in its periphery, so that it is allowed to rotate in association with gears of the external driving motor (not shown).

The fixed substrate 14 is properly fixed to the housing 13, while the rotational substrate 15 is coupled to the rotation body 17, so that the rotational substrate is allowed to rotate along with rotation of the rotation body 17. A rotation pin 16 is set in a rotation axis of the rotational substrate 15 and the rotation body coupled to each other, so that the rotational substrate 15 and the rotation body 17 are allowed to rotate about the rotation pin 16.

The variable phase shifter 10 is also provided with a dielectric disc 12 made of a predetermined dielectric constant above the fixed substrate 14, inside the housing 13. Further, an upper cover 11 and a lower cover 12 are respectively coupled to the topmost and bottommost parts of the housing 13 for supporting the elements inserted thereto, e.g., with the fixed substrate 14, the rotational substrate 15 and the rotation body 17 assembled together. As shown in FIG. 1b, a plate spring of an appropriate form may be provided beneath the rotation body 17, for providing an elastic force to push the rotation body upwardly, so that the rotation substrate 15 is allowed to engage the fixed substrate 14 tightly.

Referring now to the accompanying drawings, detailed description will be made to the construction and operation of the fixed substrate 14 and the rotational substrate 15 according to the preferred embodiment of the present invention.

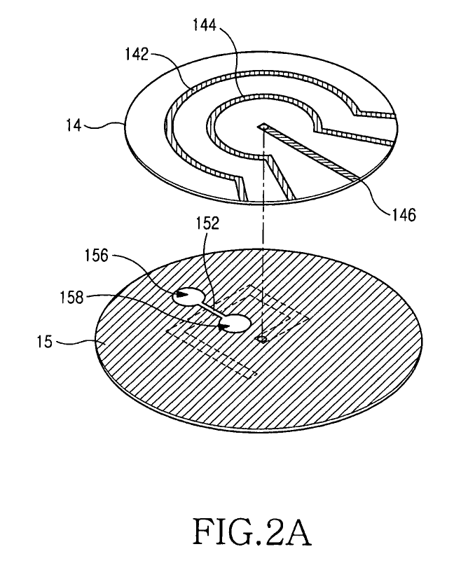

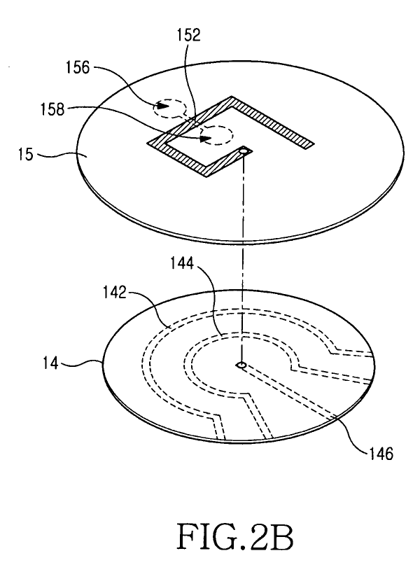

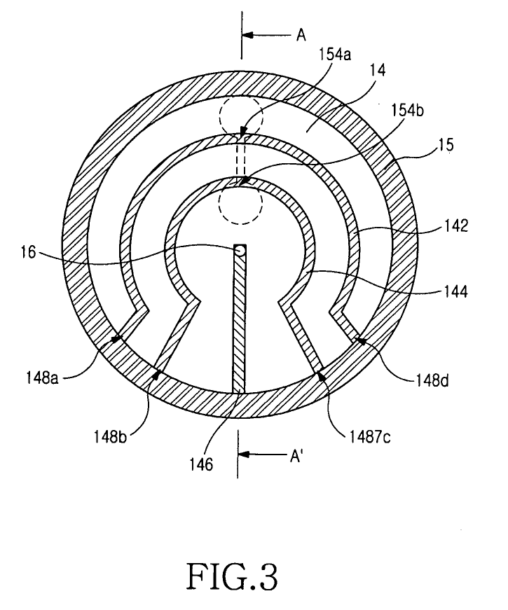

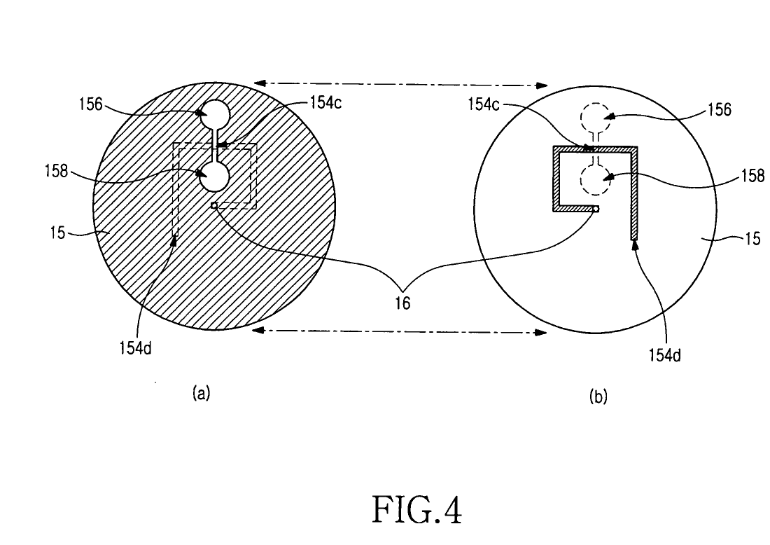

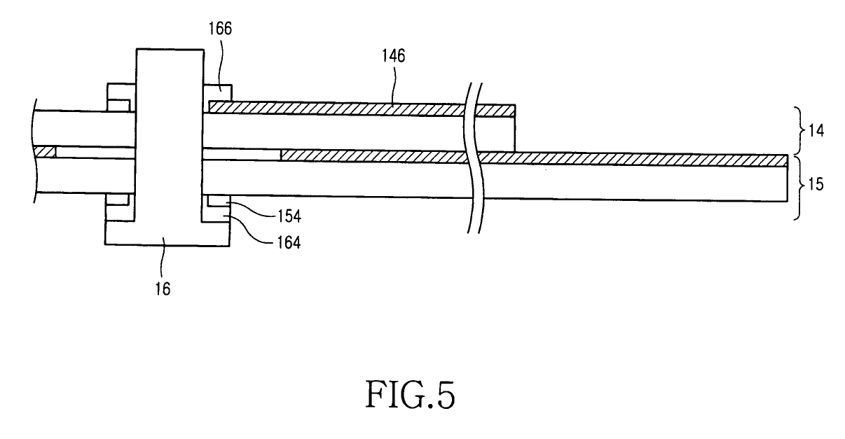

In the drawings, FIGS. 2a and 2b respectively show a detailed perspective view of the fixed substrate 14 and the rotational substrate 15 as shown in FIG. 1a, wherein FIG. 2a represents a top-side perspective view of it, while FIG. 2b represents a bottom-side perspective view of it. FIG. 3 shows a plan view of one exemplary arrangement of the fixed substrate 14 disposed on the rotational substrate 15 of FIG. 1a. FIG. 4 shows a plan view and a bottom view of the rotational substrate 15, wherein the plan view is shown in (a) and the bottom view (b). FIG. 5 schematically shows a cross-sectional view, taken along a line A-A′ of FIG. 3, of an exemplary configuration of the fixed substrate disposed on the rotational substrate of FIG. 1a.

Referring now to FIGS. 2a and 2b to FIG. 5, description is made to the construction of the variable phase shifter 10 according to a preferred embodiment of the present invention. Advantageously, the fixed substrate 14 may be made of a dielectric substance of a predetermined dielectric constant and is provided with one or more micro-strip lines 142 and 144 of a circular arc form on the upper surface thereof. The first and inner strip-line 142 and the second and outer strip-line 144 are arranged concentrically from the center of the fixed substrate 14. Both ends of the respective micro-strip lines 142 and 144 of circular arc respectively forms a first, second, third and fourth output port 148a, 148b, 148c and 148d. Each one of these first to fourth output ports 148a to 148d may be connected to a connector (not shown) inserted into a corresponding one of perforations 132 passing through a wall of the housing 13 as seen in FIGS. 1a and 1b, and it may be subsequently connected to radiation elements (not shown) of an antenna through the connector.

Further, an input strip line 146 receiving an input signal from the connector inserted into the corresponding one of the perforations 132 formed through the wall of the housing 13 is disposed on an upper surface of the fixed substrate 14, for transferring the input signal to the rotation pin 16 coupled up in the center of the fixed substrate 14.

In the meantime, the rotational substrate 15 may be generally configured of a micro-strip-slot line coupling structure, in such a manner that a transfer strip line 154, that is, a micro-strip line with an open end 154d, is formed in a lower surface of the rotational substrate 15 of a dielectric substance, while a slot line 152 for coupling with the transfer strip line 154 is formed in an upper surface of the rotational substrate 15. Here, a distance between the open end 154d and a first transfer point 154c for coupling with the slot line 152 in the strip line 154 may be preferably set to its quarter wavelength with respect to a transferred signal frequency. In the disclosed embodiment, the transfer strip line 154 is generally illustrated of a rectangular form by way of example, but it may have various different topology provided that the distance between the first transfer position 154c and the open end 154d in the slot line 152 is set to satisfy a distance corresponding to its quarter wavelength with respect to the transfer signal frequency.

Further, the other end of the transfer strip line 154 of the rotational substrate 15 is connected with the rotation pin 16 for receiving the input signal. In particular, referring to FIG. 5, an input strip line 146 of the fixed substrate 14 is connected with the rotation pin 16 through a first dielectric section 166, and the transfer strip line 154 of the rotational substrate 15 is connected with the rotation pin 16 through a second dielectric section 164. Hence, the input signal from the input strip line 146 is provided to the transfer strip line 154 through the rotation pin 16. Therefore, using this structure of the first and second dielectric substance, the rotational substrate 15 is configured in such a manner that upon revolution of the rotation body, a ground of the rotational substrate 15 fixed to the rotation body 17 is capacitively coupled with the inner surface of the housing 13 through a coupling.

A conductive thin layer, substantially made of metal, is formed on an upper surface of the rotational substrate 15, coming into touch with a bottom surface of the fixed substrate 14, for providing a slot line 152 in both sides of which a disc type of annular opening 156 and 158 is respectively formed with the conductive substance removed, thereby forming an open-circuit end. Here, it should be noted that these annular opening section 156 and 158 each serve as an open end of the circuit, so the electromagnetic energy radiation from the slot line 152 goes its maximum at a position where the both ends of the slot line 152 adjoin the disc type annular openings 156 and 158, namely, a second transfer point 154a and a third transfer point 154b as shown in FIG. 3. With this structure, the larger radius the annular opening sections 16 and 158 have, the higher its electromagnetic radiation energy goes. Advantageously, the size and location of the opening sections 156 and 158 may be designed in such a way that the positions of the second point 154a and the third transfer point 154b respectively correspond to each circular arc section of the first strip line 142 and the second strip line 144, as seen in FIG. 3. Moreover, the distance from the first transfer point 154c in the slot line 152 to both ends of the slot line 152 may extend in the same length at both directions, and the signal transferred from the transfer strip line 158 under the rotational substrate 15 to the slot line 152 is adapted to be evenly distributed towards both ends of the slot line 152.

As seen from the above description, the fixed substrate 14 may be provided with the first and second strip lines 142 and 144 on the upper surface of the dielectric section, and the bottom surface of the fixed substrate comes in contact with the rotational substrate 15 formed thereon the disc-type opening sections 156 and 158 and the slot line 152, said opening sections 156 and 158 respectively corresponding to the first and second strip lines 142 and 144. Therefore, it will be appreciated that this structure also implements a microstrip-slot line coupling. That is to say, the signals radiated from the second transfer point 154a and the third transfer point 154b of the slot line 152 are respectively transferred to the first strip line 142 and the second strip line 144.

Using the above-described structure of the fixed substrate 14 and the rotational substrate 15, the input signal received from the input strip line 146 on the fixed substrate 14 is transferred through the rotation pin 16 to the transfer strip line 154 underneath the rotational substrate 15, and then to the slot line 152 on the rotational substrate 15 through the first transfer point 154c. Subsequently, the signal is distributed to the first strip line 142 and the second strip line 144, respectively, through the second transfer point 154a and the third transfer point 154b of the slot line 152, and finally provided to first to fourth output ports 148a to 148d of the first and second strip lines 142 and 144. Here, as the rotational substrate 15 is rotatably configured, the positions in the first strip line 142 and the second strip line 144 corresponding to the second transfer point 154a and the third transfer point 154b change accordingly. Therefore, the phase difference of the signal output obtained at the first to fourth output ports 148a to 148d is allowed to change. In the following, more detailed description is made to the transfer, distribution and outputting procedures of the input signal in the embodiment of the present invention as described heretofore.

Once an input signal is received through an input port of the input strip line 146 in the fixed substrate 14, the input signal is transferred through the rotation pin 16 to the underside surface of the rotational substrate 15. When the signal is inputted through the underside of the fixed substrate 14, it is then transferred to the transfer strip line 154. Further, as the first transfer point 154c in the transfer strip line 154 is substantially positioned in a point spaced apart by a quarter wavelength of the transferred signal from the open end 154d, it is physically open or electrically short-circuited, thereby transferring the signal at the first transfer point 154c to the slot line 152 on the fixed substrate 15. The input signal transferred is then divided into the second transfer point 154a and the third transfer point 154b.

The signal transferred to the second transfer point 154a of the signals divided from the slot line 152 is transferred to the first strip line 142 on the fixed substrate 14, as it is physically open or electrically short-circuit in the second transfer point 154a due to the annular opening section 156. The signal transferred to the first strip line 142 is then distributed into both sides of the strip line, which signals are respectively supplied to the first output port 148a and the fourth output port 148d, which are subsequently provided to respective radiation elements (not shown) of the antenna.

Likewise, the signal transferred to the third transfer point 154b of the signals divided by the slot line 152 is also transferred to the second strip line 144 on the fixed substrate 14, as it is physically open or electrically short-circuit in the third transfer point 154b due to the annular opening section 158. The signal transferred to the second strip line 144 is similarly distributed into both sides of it, and these divided signals are respectively supplied to the second output port 148b and the third output port 148c, which are subsequently provided to respective radiation elements (not shown) of the antenna.

With use of this structure, the phase difference in between the output signals through the first to fourth output ports will be dependent upon a revolution of the rotational substrate 15, that is to say, the position of the transfer points of the slot line 152 on the rotational substrate 15 according to revolution of the rotational substrate 15. For instance, in case where the second transfer point 154a is located closer to the first output port 148a than to the fourth output port 148d, the signal transferred through this transfer point is divided into both the directions of the first and fourth output ports 148a and 148d, so that a length of a transmission line of the signal outputted through the fourth output port 148d is allowed to become longer than that of the signal outputted through the first output port 148a.

Accordingly, it will lead to a difference in length of the transmission lines of the signals respectively distributed to both the output ports 148a and 148d in the first strip line 142, which in turn makes a difference in phase of the output signals output through the first and fourth output port 148a and 148d. Likewise, the signal transferred through the third transfer point 154b is respectively divided into the second and third output ports 148b and 148c of the second strip line 144, thereby generating a phase difference in their output signals.

In the above embodiment, the first and second strip lines 142 and 144 of the fixed substrate 14 are configured to have the line length different from each other, so the phase difference in the output signals supplied from both output ports 148a and 148d of the first strip line 142 is different from that in the output signals supplied from both output ports 148b and 148c of the second strip line 144. For instance, a physical design may be made in such a way that the phase difference in the output signals supplied from both output ports 148b and 148d of the second strip line 142 is adapted to change between +1 and −1, while the phase difference in the output signals supplied from both output ports 148a and 148d of the first strip line 142 is adapted to change between +2 and −2. The phase difference in each output port may be selected to a given value such as +2, +1, 0, −1, or −2, thereby adaptively controlling a tilt angle of a beam radiated from the antenna as desired.

As understood from the foregoing, the variable phase shifter according to the present invention makes it possible to distribute the input signal by means of the micro strip-slot line coupling scheme using the fixed substrate 14 and the rotational substrate 15 and to make a difference in length of plural transmission lines to change the phase of the output signal. As a result, the phase shifter of the present invention has advantages that not only the overall dimension of the antenna product can be significantly reduced, but also the mechanical wear owing to frequent contacts in the strip lines may be avoided. Therefore, the variable phase shifter according to the present invention renders some degree of improvement in the performance of phase shifter.

While the variable phase shifter of the preferred embodiment of the present invention have been illustrated and described heretofore, it will be understood by those skilled in the art that various changes and modifications may be made, and equivalents may be substituted for elements thereof without departing from the true scope of the present invention. For instance, the micro-strip line as described in the above embodiment may be substituted by a strip line, a coaxial cable, a coplanar waveguide (CPW), and their equivalents. Furthermore, the slot line may be replaced by a coplanar strip (CPS).

Therefore, it is intended that the present invention not be limited to the particular embodiment disclosed as the best mode contemplated for carrying out the present invention; instead, it is intended that the present invention include all embodiments falling within the scope of the appended claims.

1. A variable phase shifter, comprising:
a housing;
a fixed substrate section, fixedly installed inside the housing, having a dielectric substrate provided with at least one micro-strip line of a circular arc type, on one side surface thereof;
a rotational substrate section, rotatably mounted into the housing, having the dielectric substrate, said rotational substrate arranged in contact with the other surface of the fixed substrate section, and having at least one slot line on the contacting surface with the fixed substrate, so that a micro-strip-slot line coupling takes place between the micro-strip line of the fixed substrate section and the slot line of the rotational substrate section upon its rotation; and
wherein both ends of the micro-strip line of the fixed substrate section respectively are connected to an output port of the variable phase shifter, and the slot line of the rotational substrate section is electrically connected to an input port of the variable phase shifter, for receiving an input signal.

2. The variable phase shifter according to claim 1, comprising:
a rotation pin arranged in the concentric center of the fixed substrate section and the rotational substrate section, serving as a revolution axis of the rotational substrate section;
an input strip line formed on one surface of the fixed substrate section, for connection of the input port and the rotation pin; and
wherein the slot line of the rotational substrate section is electrically connected with the rotation pin for receiving the input signal from the input port.

3. The variable phase shifter according to claim 2, wherein the rotational substrate section comprises a transfer strip line that is a micro strip line with an open end on the opposite surface of the surface provided with the slot line thereon, said transfer strip line contributing to a micro-strip-slot line coupling between the micro-strip line and the slot line, and the transfer strip line is electrically connected with the rotation pin, through which the input signal is received and then transferred to the slot line.

4. A variable phase shifter, comprising:
a housing;
a fixed substrate section, fixedly installed inside the housing, having a dielectric substrate provided with at least two micro-strips of concentric circular arcs on one side surface thereof;
a rotational substrate section, rotatably mounted into the housing, having the dielectric substrate, said rotational substrate being arranged into contact with the other surface of the fixed substrate section, and having at least one slot line on the surface adjoining the fixed substrate, so that a micro-strip-slot line coupling takes place between said at least two micro-strip lines of the fixed substrate section and the slot line upon its rotation, said rotational substrate section comprising a transfer strip line that is of a micro strip line with an open end on the opposite surface of the surface provided with the slot line thereon, said transfer strip line contributing to the micro-strip-slot line coupling with the slot line;
a rotation body, coupled with the rotational substrate section, for driving the rotational substrate to revolve with the aid of an outside power; and
wherein both ends of the two micro-strip line of the fixed substrate section respectively are connected to an output port of the variable phase shifter, and the transfer strip line of the rotational substrate section is electrically connected to an input port of the variable phase shifter, for receiving an input signal therefrom.

5. The variable phase shifter according to claim 4, comprising:
a rotation pin arranged in the concentric center of the fixed substrate section and the rotational substrate section, serving as a revolution axis of the rotational substrate section;
an input strip line formed on one side surface of the fixed substrate section, for connection of the input port and the rotation pin; and
wherein the transfer strip line of the rotational substrate section is electrically connected with the rotation pin for receiving the input signal from the input port.

6. The variable phase shifter according to claim 4 or 5, wherein both ends of the slot line are respectively formed with an open-end circuit.

7. A variable phase shifter, comprising:
a housing;
a fixed substrate section, fixedly installed inside the housing, having a dielectric substrate provided with at least one transmission line of a circular arc type, on one side surface thereof;
a rotational substrate section, rotatably mounted into the housing, said rotational substrate arranged in contact with the other surface of the fixed substrate section, said rotational substrate section comprising the dielectric substrate having at least one slot line on the surface contacting the fixed substrate, so that a signal transfer is made with the circular transmission line of the fixed substrate section even while its rotation; and
wherein both ends of said at least one transmission line of the fixed substrate section respectively are connected to an output port of the variable phase shifter, and the slot line of the rotational substrate section is electrically connected to an input port of the variable phase shifter, so as to receive an input signal therefrom.

8. The variable phase shifter according to claim 7, comprising:
a rotation pin arranged in the concentric center of the fixed substrate section and the rotational substrate section, serving as a revolution axis of the rotational substrate section;
an input strip line formed on one surface of the fixed substrate section, for connection of the input port and the rotation pin; and
wherein the slot line of the rotational substrate section is electrically connected with the rotation pin for receiving the input signal from the input port.

9. The variable phase shifter according to claim 8, wherein the rotational substrate section comprises a transfer strip line having an open end on the opposite surface of the surface provided with the slot line thereon, said transfer strip line contributing to a signal transfer with the slot line, and the transfer strip line is electrically connected with the rotation pin, through which the input signal is received and then transferred to the slot line.

10. The variable phase shifter-according to claim 7, wherein the transmission line is formed of either one of a micro-strip line, a strip line coaxial cable, and coplanar waveguide (CPW).

11. The variable phase shifter according to claim 8, wherein the transmission line is formed of either one of a micro-strip line, a strip line coaxial cable, and coplanar waveguide (CPW).

12. The variable phase shifter according to claim 9, wherein the transmission line is formed of either one of a micro-strip line, a strip line coaxial cable, and coplanar waveguide (CPW).
